(19) United States
(12) Patent Application Publication
(10) Pub. No.: US 2026/0230498 A1
(43) Pub. Date: Aug. 6, 2026

(54) TECHNIQUES FOR CORRELATING EXTERNAL ATTACK SURFACE WITH INTERNAL NETWORK RESOURCES

(71) Applicant: Cycognito, Ltd., Tel Aviv (IL)

(72) Inventors: Dima POTEKHIN, Tel Aviv (IL); Rob N GURZEEV, Palo Alto, CA (US)

(73) Assignee: Cycognito, Ltd., Tel Aviv (IL)

(21) Appl. No.: 19/045,274

(22) Filed: Feb. 4, 2025

(51) Int. Cl. H04L 9/40

(52) U.S. Cl. CPC H04L 63/1441

(57) ABSTRACT

A system and method for correlating an external attack surface with an internal workload deployed in a computing environment is presented. The method includes detecting a plurality of persistent digital assets, each persistent digital asset associated with an organization; receiving a scan result of a computing environment of the organization, the computing environment including a plurality of deployed resources; matching a first persistent digital asset of the plurality of persistent digital assets to a first deployed resource of the plurality of deployed resources detected in the scan result; applying a policy based on the match; and initiating a mitigation action in the computing environment based on a result of the applied policy.

### TECHNICAL FIELD

The present disclosure relates generally to external attack surface management, and specifically to correlating external attack surface with internal network resources for detecting weak points in network security.

### BACKGROUND

External Attack Surface Management (EASM) involves identifying, monitoring, and mitigating risks associated with an organization's externally facing digital assets. These assets, which include websites, APIs, cloud services, IP addresses, and third-party integrations, form the external attack surface and are potential entry points for cyberattacks. The goal of EASM is to continuously map and assess this attack surface to reduce vulnerabilities and prevent exploitation by malicious actors.

The dynamic nature of modern IT environments makes EASM challenging. Organizations frequently adopt new technologies, deploy cloud resources, or integrate third-party services, often without fully cataloging these changes. Shadow IT, where employees use unauthorized tools or systems, further complicates visibility into the attack surface. The rapid pace of digital transformation exacerbates this issue, leading to gaps in security coverage.

Another significant challenge lies in the sheer volume of data. Security teams must analyze vast amounts of information to detect misconfigurations, vulnerabilities, or outdated software across numerous assets. Prioritizing risks becomes difficult, particularly when false positives or low-priority alerts clutter the assessment process.

Additionally, organizations face the complexity of managing risks associated with third-party vendors and supply chains. Security gaps in a partner's infrastructure can expose the organization to indirect threats. Monitoring these external dependencies requires robust tools and processes, which are often lacking or insufficiently mature.

Cybercriminals exploit these challenges by targeting overlooked or poorly managed assets. Organizations must therefore adopt a proactive approach, combining automated tools with human expertise to ensure continuous visibility, accurate risk prioritization, and timely remediation. The ever-changing nature of the external attack surface makes EASM an ongoing and evolving process, requiring consistent effort to maintain a strong security posture.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include detecting a plurality of persistent digital assets, each persistent digital asset associated with an organization. The method may also include receiving a scan result of a computing environment of the organization, the computing environment including a plurality of deployed resources. The method may furthermore include matching a first persistent digital asset of the plurality of persistent digital assets to a first deployed resource of the plurality of deployed resources detected in the scan result. The method may in addition include applying a policy based on the match. The method may moreover include initiating a mitigation action in the computing environment based on a result of the applied policy. Other embodiments of this aspect include corresponding computer systems, apparatus, and computer programs recorded on one or more computer storage devices, each configured to perform the actions of the methods.

Implementations may include one or more of the following features. The method may include: generating a first fingerprint for the first persistent digital asset; generating a second fingerprint for the first deployed resource; and generating the match based on the first fingerprint and the second fingerprint. The method may include: generating the first fingerprint based on detected attributes of the first persistent digital asset. The method may include: generating the second fingerprint based on the scan result of the first deployed resource. The method may include: periodically detecting the persistent digital assets as an external attack surface of a plurality of networked computing environments of the organization. The method may include: periodically receiving scan results from a cybersecurity monitoring system configured to scan the computing environment for internal workloads. The method may include: periodically receiving scan results from the cybersecurity monitoring system including detected cybersecurity risks. The method may include: generating a representation of the first persistent digital asset, and a representation of the first deployed resource; determining that the first persistent digital asset includes a cybersecurity risk based on a connection between the representations. Implementations of the described techniques may include hardware, a method or process, or a computer tangible medium.

In one general aspect, non-transitory computer-readable medium may include one or more instructions that, when executed by one or more processors of a device, cause the device to: detect a plurality of persistent digital assets, each persistent digital asset associated with an organization; receive a scan result of a computing environment of the organization, the computing environment including a plurality of deployed resources; match a first persistent digital asset of the plurality of persistent digital assets to a first deployed resource of the plurality of deployed resources detected in the scan result; apply a policy based on the match; and initiate a mitigation action in the computing environment based on a result of the applied policy. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: detect a plurality of persistent digital assets, each persistent digital asset associated with an organization. The system may in addition receive a scan result of a computing environment of the organization, the computing environment including a plurality of deployed resources. The system may moreover match a first persistent digital asset of the plurality of persistent digital assets to a first deployed resource of the plurality of deployed resources detected in the scan result. The system may also apply a policy based on the match. The system may furthermore initiate a mitigation action in the computing environment based on a result of the applied policy. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: generate a first fingerprint for the first persistent digital asset; generate a second fingerprint for the first deployed resource; and generate the match based on the first fingerprint and the second fingerprint. The system where the memory contains further instructions which when executed by the processing circuitry further configure the system to: generate the first fingerprint based on detected attributes of the first persistent digital asset. The system where the memory contains further instructions which when executed by the processing circuitry further configure the system to: generate the second fingerprint based on the scan result of the first deployed resource. The system where the memory contains further instructions which when executed by the processing circuitry further configure the system to: periodically detect the persistent digital assets as an external attack surface of a plurality of networked computing environments of the organization. The system where the memory contains further instructions which when executed by the processing circuitry further configure the system to: periodically receive scan results from a cybersecurity monitoring system configured to scan the computing environment for internal workloads. The system where the memory contains further instructions which when executed by the processing circuitry further configure the system to: periodically receive scan results from the cybersecurity monitoring system including detected cybersecurity risks. The system where the memory contains further instructions which when executed by the processing circuitry further configure the system to: generate a representation of the first persistent digital asset, and a representation of the first deployed resource; and determine that the first persistent digital asset includes a cybersecurity risk based on a connection between the representations. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a computing environment having persistent digital assets discovered by an external attack surface detector, utilized to describe an embodiment.

FIG. 2 is an example flowchart of a method for correlating an external attack surface with internal workloads, implemented in accordance with an embodiment.

FIG. 3 is an example schematic diagram of a detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to an embodiment, a system is configured to detect persistent digital assets through an external attack surface. In an embodiment, detecting a persistent digital asset is beneficial, as having an accurate view of an external attack surface is beneficial, for example for cybersecurity mitigation, remediation, and the like.

In some embodiments, a representation of a digital asset is generated based on information detected through a public network, such as the Internet. In an embodiment, information pertaining to a digital asset changes over time. For example, a digital asset has a first state at a first point of time, and a second state at a second point in time. In an embodiment, a state includes an IP address, an operating system, a viable network communication port, combinations thereof, and the like, as explained in more detail with respect to embodiments herein.

In an embodiment, it is beneficial to detect persistent digital assets, despite changes such as software updates, IP address changes, domain name changes, and the like, which occur over time.

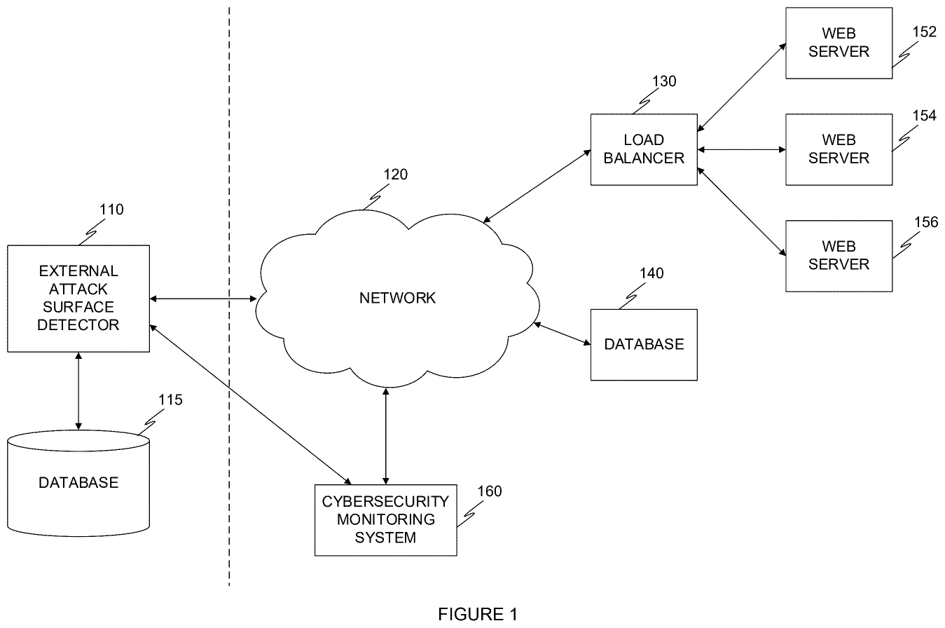

FIG. 1 is a network diagram of a computing environment having persistent digital assets discovered by an external attack surface detector, utilized to describe an embodiment. A network computing environment, according to an embodiment, includes virtual digital assets, physical digital assets, combinations thereof, and the like.

In an embodiment, a virtual digital asset is a virtual machine, a software container, a serverless function, a virtual appliance, an application image, a web server, a load balancer, a database, a distributed storage service, a combination thereof, and the like.

In some embodiments, a physical digital asset is a bare metal machine, a server rack, a processor, a memory, a storage, combinations thereof, and the like.

In an embodiment, a computing environment includes a load balancer 130, which exposes web servers, such as a first web server 152, a second web server 154, and a third web server 156. In some embodiments, the computing environment includes a database 140. In certain embodiments, the computing environment, elements thereof, and the like, are connected to a network 120.

In some embodiments, the network 120 includes, but is not limited to, a wireless, cellular or wired network, a local area network (LAN), a wide area network (WAN), a metro area network (MAN), the Internet, the worldwide web (WWW), similar networks, and any combination thereof.

According to an embodiment, a computing environment includes an external attack surface. An external attack surface includes, in an embodiment, machines, devices, digital assets, physical assets, and the like, which are exposed through a network 120, an external network (i.e., a network which is external to a network of the computing environment), a public network, combinations thereof, and the like.

For example, in an embodiment, a load balancer 130 is part of a computing environment's external attack surface, as the load balancer 130 is exposed to a network which includes network elements that are not part of the computing environment. For example, a load balancer 130 that is exposed to the Internet is part of an attack surface, according to an embodiment. Gaining access through an external attack surface is a common way attackers gain access to network computing environments. It is therefore advantageous to detect an organization's external attack surface, so that cybersecurity measures can be put in place, including deterring attackers, remediate attacks, mitigate attacks, and the like.

In certain embodiments, an external attack surface detector 110 is configured to detect a computing environment's external attack surface. In some embodiments, a computing environment is a cloud computing environment, a networked computing environment, a hybrid computing environment, a combination thereof, and the like.

In some embodiments, a cloud computing environment is a virtual private cloud (VPC), a virtual network (VNet), and the like. In certain embodiments, a cloud computing environment is deployed on a cloud computing infrastructure, such as Amazon® Web Services (AWS), Google® Cloud Platform (GCP), Microsoft® Azure®, and the like.

In an embodiment, an external attack surface detector 110 is configured to detect the computing environment's external attack surface, based on an identifier of an organization. For example, according to an embodiment, a detector 110 is configured to detect a domain name service (DNS) record based on the organization identifier. In an embodiment, a DNS record is detected by querying a DNS server with the organization identifier. An organization identifier is, for example, a legal entity name, a subsidiary name, a tax ID number, a company ID number, a combination thereof, and the like.

In certain embodiments, a DNS query returns a response including a plurality of network addresses. For example, according to an embodiment, a DNS query response includes a static IP address, a dynamic IP address, a combination thereof, and the like.

In an embodiment, a network protocol message is generated based on a network address detected in the DNS query response. For example, in an embodiment, a network protocol message includes generating a PING command to an IP address, a range of IP addresses, and the like, and receiving a response to the network protocol message.

In certain embodiments, the network protocol is TCP/IP, UDP, HTTP, SSH, a combination thereof, and the like. In some embodiments, the network protocol message is delivered over a unique port, a plurality of unique ports, and the like. For example, in an embodiment, an HTTP message is generated, and the same message is transmitted over port 80 and port 8080 to the same IP address.

According to an embodiment, a reply is received in response to sending the network protocol message. For example, in an embodiment, an HTTP response includes a code, such as 304, 503, etc. In certain embodiments, a detector 110 is configured to generate a representation of a digital asset based on a predefined data schema and store such a representation in a database 115. For example, in an embodiment, the detector 110 is configured to generate a representation of a digital asset based on digital asset information.

In an embodiment, digital asset information includes a network address, a network address range, a domain identifier, a sub-domain name, a namespace identifier, a MAC address, an operating system identifier, an application version, an application identifier, a certificate, a hash of a certificate, a checksum result, a web application, an HTML code, a combination thereof, and the like.

In an embodiment, the detector 110 is configured to extract a value from digital asset information and store the extracted value in a representation of the digital asset, for example in the database 115. Digital assets are often not static across time, which presents a challenge in identifying persistent digital assets. As a simple example, a digital asset has a first IP address at a first time, and a second IP address at a second time. This can occur, for example, due to a change in a static IP of a domain. In an embodiment, such a change is detected based on a DNS record.

In certain embodiments, the detector 110 is configured to detect when digital asset information applies to an existing digital asset (e.g., a change of IP address), or when digital asset information applies to a new digital asset. In some embodiments the detector 110 is configured to apply a policy, a rule, a conditional rule, a heuristic, a combination thereof, and the like, to determine if digital asset information is applied to a new digital asset or a previously detected digital asset.

In some embodiments, a digital asset representation includes a plurality of attributes, each attribute having a corresponding value. For example, in an embodiment, the detector 110 is configured to detect, extract, and the like, a value from digital asset information, and store such an extracted value in the digital asset representation of the digital asset.

In some embodiments, the detector is configured to determine if a digital asset information applies to a new digital asset or a previously detected digital asset based on a threshold. For example, in an embodiment, an attribute includes a threshold, a change threshold, and the like. In certain embodiments, where an attribute value changes at a frequency that exceeds the threshold, the digital asset information is determined to be a new digital asset.

In certain embodiments, the threshold is applied to a number of attributes changing together. For example, where digital asset information includes the same IP address with a different port, for the same protocol, the detector 110 is configured to determine that the digital asset is the previously detected digital asset (i.e., only one attribute changed). In an embodiment, where the digital asset information includes a different IP address, a different port, and the same protocol, the detector 110 is configured to determine that the digital asset information applies to a new digital asset.

In some embodiments, certain changes are disregarded in determining if the digital asset is a previously detected digital asset or not. For example, where a DNS record indicates that a domain changed an IP address, then each digital asset associated with the domain has likely changed the IP address as well, and therefore the digital asset information pertaining to that digital asset is determined based on other factors, attributes, and the like, which are not the IP address.

According to an embodiment, a digital asset representation includes a generated fingerprint. For example, in an embodiment, the detector 110 is configured to generate a fingerprint for a digital asset based on at least an attribute. In some embodiments, the fingerprint is a hash value.

In an embodiment, the detector 110 is configured to detect an asset group. For example, the plurality of web servers 152 through 156 are an asset group, according to an embodiment. Detecting asset groups allows for unifying assets and provides context for an asset, such as by providing a business context.

In some embodiments, the assets of the organization are monitored by a cybersecurity monitoring system 160, which is configured to detect internal resources, such as the load balancer 130, database 140, etc. According to an embodiment, the cybersecurity monitoring system 160 is configured to detect internal resources using access to the organization network.

In certain embodiments, the cybersecurity monitoring system 160 is not configured to detect an external attack surface. In some embodiments, the cybersecurity monitoring system 160 is configured to store a result of scanning the internal network in the database 115. In an embodiment, the cybersecurity monitoring system 160 is configured to communicate with the detector 110, which in turn is configured to correlate the detected persistent digital assets with the detected internal resources.

For example, in an embodiment, the detector 110 is configured to detect a group of resources which utilize a single IP address. The cybersecurity monitoring system 160 detects a load balancer 130 having an internal IP address and an external IP address, which is also connected to a plurality of web servers 152 through 156, all having internal IP addresses. By correlating the load balancer's external and internal IP addresses, a full network path from the external network into the internal components is detected.

According to an embodiment, the detector 110 is configured to correlate internal resources with persistent digital assets based on a determined geolocation. For example, in an embodiment, where an internal asset is detected in a first geolocation, and a persistent digital asset is detected having an IP address which is known to correspond to the first geolocation, the detector 110 is configured to match the persistent digital asset to the internal resource.

In certain embodiments, the detector 110 is configured to match a persistent digital asset to an internal resource based on generated fingerprints. For example, in an embodiment, the detector 110 is configured to generate a fingerprint for the persistent digital asset based on values of attributes of the persistent digital asset.

In some embodiments, the detector 110 is configured to generate a fingerprint for a detected internal resource based on attributes of the detected internal resource. Such attributes may be, for example, an IP address, a software application identifier, an OS identifier, an attribute of a hardware associated with the internal resource (e.g., processor speed, memory size, storage size, etc.), a combination thereof, and the like.

In an embodiment, a computing environment is configured to generate alerts, notifications, and the like, for various assets, components, etc., which are deployed therein. By generating an asset group, alerts can likewise be grouped, so as to generate fewer alerts, and increase the relevance of those alerts which are ultimately generated.

For example, according to an embodiment, the load balancer 130 experiences a malfunction. The load balancer 130 then generates a notification of the malfunction. Simultaneously, the web servers 152 through 156 detect no network connectivity, and likewise generate notifications. There are now four components in the computing environment generating notifications for what is essentially a single event. By grouping the load balancer 130 and web servers 152 through 156 as a single asset, a primary alert is generated based on the notifications of each component, thus reducing the overall number of alerts significantly, and reducing alert fatigue.

Alert fatigue occurs when individuals, such as IT or security professionals, are overwhelmed by a high volume of alerts, often including false positives or low-priority notifications. This leads to desensitization, where critical alerts may be ignored or missed, increasing the risk of significant incidents going unnoticed. It is a common issue in environments with poorly tuned monitoring systems, making it essential to prioritize, filter, and contextualize alerts to ensure effective response.

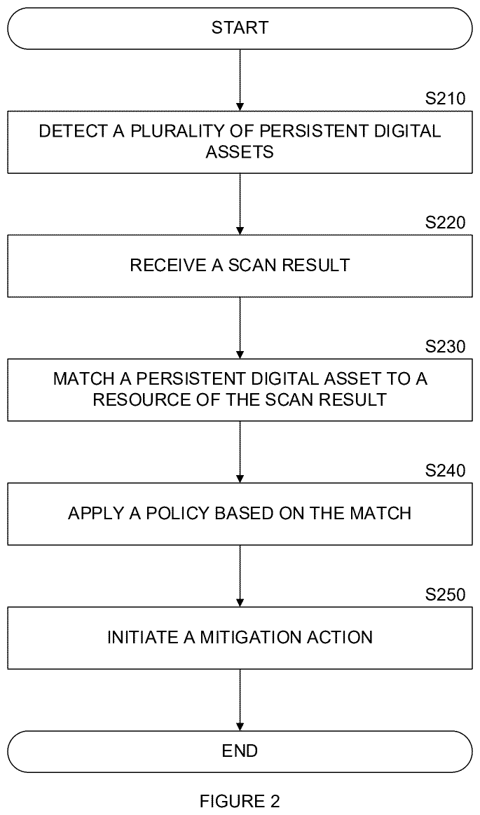

FIG. 2 is an example flowchart of a method for correlating an external attack surface with internal workloads, implemented in accordance with an embodiment. Used herein, the terms resource, workload, virtualization, and the like, are interchangeable in certain embodiments. For example, a virtual machine, a software container, a combination thereof, and the like, are a resource, workload, virtualization, etc., in a context. According to some embodiments, a software application, operating system, software service, and the like, are considered a resource.

In some embodiments, a detector is configured to correlate an external attack surface with an internal workload. This allows the detection of vulnerable points in a computing network and, additionally, to determine an impact on an internal workload if such a vulnerable point is exploited.

At S210, a plurality of persistent digital assets are detected. In an embodiment, each persistent digital asset associated with an organization. For example, according to an embodiment, an external attack surface detector is configured to detect digital assets associated with an organization and determine which of these detected digital assets are persistent digital assets.

In an embodiment, detecting a persistent digital asset includes detecting attributes of a digital asset. In an embodiment, an attribute is for example, an IP address, a software application identifier, an OS identifier, an attribute of a hardware associated with the internal resource (e.g., processor speed, memory size, storage size, etc.), a combination thereof, and the like.

At S220, a scan result is received. In an embodiment, the result is received from a cybersecurity monitoring system. For example, in an embodiment, the cybersecurity monitoring system is configured to detected a plurality of resources deployed in the computing environment. According to an embodiment, the computing environment is associated with the organization of the detected persistent digital assets.

In an embodiment, the scan result includes detecting software applications, IP addresses, IP address ranges, cybersecurity risks, a combination thereof, and the like. In some embodiments, a plurality of cybersecurity monitoring systems are deployed. In an embodiment a first cybersecurity monitoring system is configured to detect certain elements of a computing environment, and a second cybersecurity monitoring system is configured to detected other elements of the computing environment, each system configured to provide an external attack surface detector with scan results.

In certain embodiments, a first cybersecurity monitoring system is configured to monitor a first computing environment of an organization, and a second cybersecurity monitoring system is configured to monitor a second computing environment of the organization. In some embodiments, the organization includes a networked computing environment, a hybrid computing environment, an on-prem computing environment, a cloud computing environment, a combination thereof, and the like.

At S230, a persistent digital asset is matched to a resource. In an embodiment, the persistent digital asset is matched to a resource which is deployed in the computing environment. A deployed resource is a resource which a cybersecurity monitoring system detects as active in the computing environment. For example, a virtual machine operational in a VPC cloud computing environment is a deployed resource, according to an embodiment.

In certain embodiments, matching a persistent digital asset to a resource is performed based on attributes of the digital asset, attributes of the resource, a combination thereof, and the like. For example, in an embodiment, a persistent digital asset is matched to a resource in response to detecting an open port on the persistent digital asset and detecting the same open port (i.e., port number) on the resource, where the port is not a typical port. For example, some ports are rarely, if ever used, and a probability that two unrelated assets in a computing environment have such a port open is low, therefore it is likely the same asset.

In some embodiments, a fingerprint is generated for each digital asset, and a fingerprint is generated for each resource. In certain embodiments, a fingerprint is generated based on an attribute, value of an attribute, behavior of the resource, behavior of the digital asset, a combination thereof, and the like.

According to an embodiment, a fingerprint is a vector, a hash, a unique identifier, various combinations thereof, and the like. In an embodiment, a representation of the persistent digital asset, a representation of the detected resource, metadata related thereto, and the like, is stored in a database. In some embodiments, a fingerprint is metadata related to a representation. In certain embodiments, where a match is detected between a fingerprint of a digital asset and a fingerprint of a resource, the representations of each are connected.

In an embodiment, two fingerprints are considered matching where a semantic distance between each fingerprint, a Levenshtein distance between the fingerprints, a sine distance between the fingerprints, and the like, is lower than a predetermined threshold.

At S240, a policy is applied. In an embodiment, the policy is applied based on the match. For example, according to an embodiment, a policy includes a rule, a condition, and the like. In some embodiments, applying a policy on a match includes applying a policy on a representation of a resource, on a representation of a persistent digital asset, on a combination thereof, and the like.

In an embodiment, a policy includes an action that is initiated in response to determining that a condition of the policy is satisfied. For example, in an embodiment, in response to detecting a match between a first persistent digital asset and a first resource, a policy is applied on their respective representations, which include attribute values of each. In an embodiment, where the policy condition is satisfied, an action is initiated. An action may be, for example, generating an alert.

At S250, a mitigation action is initiated. In an embodiment, the mitigation action is initiated in the computing environment based on a result of the applied policy. In some embodiments, the mitigation action is initiated in the computing environment, in another computing environment associated with the organization, a combination thereof, and the like.

In certain embodiments, the mitigation action includes generating an alert, generating a notification, opening a ticket in an issue monitoring system, a combination thereof, and the like. In some embodiments, the mitigation action includes providing a remediation action and providing suggested remediation actions.

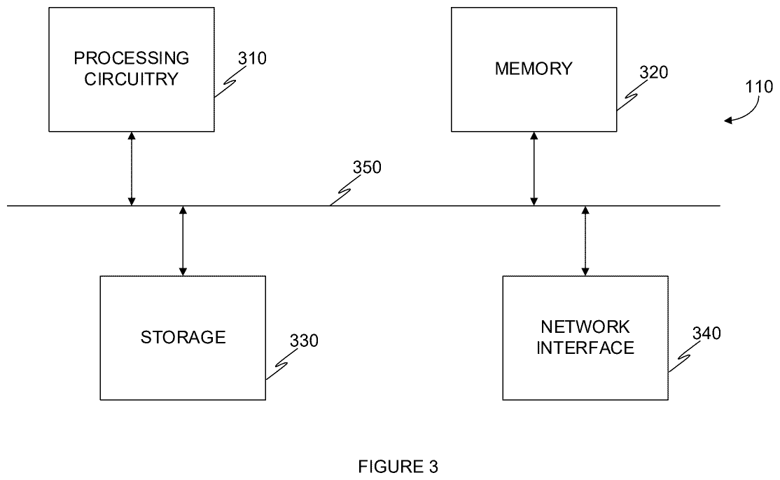

FIG. 3 is an example schematic diagram of a detector 110 according to an embodiment. The detector 110 includes, according to an embodiment, a processing circuitry 310 coupled to a memory 320, a storage 330, and a network interface 340. In an embodiment, the components of the detector 110 are communicatively connected via a bus 350.

In certain embodiments, the processing circuitry 310 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 320 is a volatile memory (e.g., random access memory, etc.), a non-volatile memory (e.g., read-only memory, flash memory, etc.), a combination thereof, and the like. In some embodiments, the memory 320 is an on-chip memory, an off-chip memory, a combination thereof, and the like. In certain embodiments, the memory 320 is a scratch-pad memory for the processing circuitry 310.

In one configuration, software for implementing one or more embodiments disclosed herein is stored in the storage 330, in the memory 320, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 310, cause the processing circuitry 310 to perform the various processes described herein, in accordance with an embodiment.

In some embodiments, the storage 330 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 340 is configured to provide the detector 110 with communication with, for example, the network 120, the database 115, the cybersecurity monitoring system 160, a combination thereof, and the like, according to an embodiment.

It should be understood that the embodiments described herein are not limited to the specific architecture illustrated in FIG. 3, and other architectures may be equally used without departing from the scope of the disclosed embodiments.

Furthermore, in certain embodiments the detector 110, database 115, cybersecurity monitoring system 160, a combination thereof, and the like, may be implemented with the architecture illustrated in FIG. 3. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for correlating an external attack surface with an internal workload deployed in a computing environment, comprising;
detecting a plurality of persistent digital assets, each persistent digital asset associated with an organization;
receiving a scan result of a computing environment of the organization, the computing environment including a plurality of deployed resources;
matching a first persistent digital asset of the plurality of persistent digital assets to a first deployed resource of the plurality of deployed resources detected in the scan result;
applying a policy based on the match; and
initiating a mitigation action in the computing environment based on a result of the applied policy.

2. The method of claim 1, further comprising:
generating a first fingerprint for the first persistent digital asset;
generating a second fingerprint for the first deployed resource; and
generating the match based on the first fingerprint and the second fingerprint.

3. The method of claim 2, further comprising:
generating the first fingerprint based on detected attributes of the first persistent digital asset.

4. The method of claim 2, further comprising:
generating the second fingerprint based on the scan result of the first deployed resource.

5. The method of claim 1, further comprising:
periodically detecting the persistent digital assets as an external attack surface of a plurality of networked computing environments of the organization.

6. The method of claim 1, further comprising:
periodically receiving scan results from a cybersecurity monitoring system configured to scan the computing environment for internal workloads.

7. The method of claim 6, further comprising:
periodically receiving scan results from the cybersecurity monitoring system including detected cybersecurity risks.

8. The method of claim 7, further comprising:
generating a representation of the first persistent digital asset, and a representation of the first deployed resource;
determining that the first persistent digital asset includes a cybersecurity risk based on a connection between the representations.

9. A non-transitory computer-readable medium storing a set of instructions for correlating an external attack surface with an internal workload deployed in a computing environment, the set of instructions comprising:
one or more instructions that, when executed by one or more processors of a device, cause the device to:
detect a plurality of persistent digital assets, each persistent digital asset associated with an organization;
receive a scan result of a computing environment of the organization, the computing environment including a plurality of deployed resources;
match a first persistent digital asset of the plurality of persistent digital assets to a first deployed resource of the plurality of deployed resources detected in the scan result;
apply a policy based on the match; and
initiate a mitigation action in the computing environment based on a result of the applied policy.

10. A system for correlating an external attack surface with an internal workload deployed in a computing environment comprising:
a processing circuitry;
a memory, the memory containing instructions that, when executed by the processing circuitry, configure the system to:
detect a plurality of persistent digital assets, each persistent digital asset associated with an organization;
receive a scan result of a computing environment of the organization, the computing environment including a plurality of deployed resources;
match a first persistent digital asset of the plurality of persistent digital assets to a first deployed resource of the plurality of deployed resources detected in the scan result;
apply a policy based on the match; and
initiate a mitigation action in the computing environment based on a result of the applied policy.

11. The system of claim 10, wherein the memory contains further instructions which when executed by the processing circuitry further configure the system to:
generate a first fingerprint for the first persistent digital asset;
generate a second fingerprint for the first deployed resource; and
generate the match based on the first fingerprint and the second fingerprint.

12. The system of claim 11, wherein the memory contains further instructions which when executed by the processing circuitry further configure the system to:
generate the first fingerprint based on detected attributes of the first persistent digital asset.

13. The system of claim 11, wherein the memory contains further instructions which when executed by the processing circuitry further configure the system to:
generate the second fingerprint based on the scan result of the first deployed resource.

14. The system of claim 10, wherein the memory contains further instructions which when executed by the processing circuitry further configure the system to:
periodically detect the persistent digital assets as an external attack surface of a plurality of networked computing environments of the organization.

15. The system of claim 10, wherein the memory contains further instructions which when executed by the processing circuitry further configure the system to:
periodically receive scan results from a cybersecurity monitoring system configured to scan the computing environment for internal workloads.

16. The system of claim 15, wherein the memory contains further instructions which when executed by the processing circuitry further configure the system to:
periodically receive scan results from the cybersecurity monitoring system including detected cybersecurity risks.

17. The system of claim 16, wherein the memory contains further instructions which when executed by the processing circuitry further configure the system to:
generate a representation of the first persistent digital asset, and a representation of the first deployed resource; and
determine that the first persistent digital asset includes a cybersecurity risk based on a connection between the representations.
